(19) United States
(12) Patent Application Publication
(10) Pub. No.: US 2020/0101351 A1
(43) Pub. Date: Apr. 2, 2020

(54) Determining and Receiving Workout Recommendations based on Imaged Dimensional Changes to Body Parts

(71) Applicant: George Page, Burlingame, CA (US)

(72) Inventor: George Page, Burlingame, CA (US)

(21) Appl. No.: 16/143,858

(22) Filed: Sep. 27, 2018

(51) Int. Cl. A63B 24/00; G06T 7/60; G06F 16/245; G09B 19/00

(52) U.S. Cl. CPC A63B 24/0075; G06T 7/60; H04N 5/23238; G09B 19/0092; G06F 16/245

(57) ABSTRACT

Embodiments of the disclosure utilize technology to provide dimensional data for individual body parts. Individual body part dimensions can be compared to one another to provide a factor of Waist to Hip Ratio. The difference in waist and hip dimensions is used to provide a waist to hip ratio which is compared with future scans and used to provide a proportionality of an average workout recommendation to individuals to tone up or build muscle.

### RELATED APPLICATIONS

This application claims the benefit under provisions of 35 U.S.C. .sctn. 119(e) of U.S. Provisional Application No. 62/563,750 filed Sep. 27, 2017, entitled Asizer Measurement Sizing Application which is incorporated herein by reference.

### BACKGROUND

Over 45 million Americans are on diets. 95% of those who have lost more than 10 pounds will gain it back within 18 months. There has been a long felt but unmet need for a solution that reduces the risk of those on diets gaining back weight lost, even more so for a solution that can be used on their phone allowing workout recommendations to be provided in the comfort of someone's own home.

Commonly used methods for measuring loss or gain involve physical devices such as tape measuring instruments or body scanning devices used in hospitals and laboratories. Electronic tape measuring devices are cumbersome and difficult to transport. Such devices lack the ability to measure any individual body to determine loss or gain in any individual body part and provide workout recommendations which vary based on a waist to hip ratio and the deviation of an individual waist to hip ratio to the average waist to hip ratio of human beings.

Workout instructional professionals, workout programs, and material aides provide workout recommendations based on desired outcomes/results. The amount of workout needed to obtain desired outcomes can only be determined by understanding the current state of a body. Body scanners and measurement devices are impractical for common persons and their individual workout needs.

### SUMMARY

Embodiments of this disclosure allow technology thru the use of an app to calculate the dimensions of any part of someone's body and the loss or gain over time of that same body part. This allows for understanding the current state of an individual and the ability to calculate personalized workout recommendations electronically using that information. Thus, providing personalized workout recommendations is possible with embodiments of this disclosure and their technological innovations. This technology gauges individual body part dimensions and the loss or gain over time in individual body parts and additionally, provides personalized workout recommendations to match current state with desired workout outcomes.

In particular, embodiments of the disclosure allow any individual to use the app to receive image measured dimensional changes to each part of their body and receive workout recommendations to build muscle or burn fat.

An embodiment of the disclosure involves image capture, quantification analytics, comparative analysis, and recommendation population. Image capture is completed by using computer vision analytic tools which allows for capturing and rendering sizing data taken from use of a 360 degree photo within the app. and quantifying loss or gain on any person instantly.

Understanding loss or gain is valuable for recommendation determination. Determinations that improve the health of an individual may be determined once loss or gain in any specific area of the body is known. Conventional recommendations related to work-outs currently involve a personal trainer who by eye judges progress and makes recommendations. In contrast, embodiments of this disclosure through technology eliminate this human eye process by quantifying loss or gain and calculating exact workout recommendations much better than the human eye. Both the foregoing overview summary and the following example embodiments are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the example embodiment.

[symbol]

### BRIEF DESCRIPTION OF THE DRAWINGS

The accompanying drawings, which are incorporated in and constitute a part of this disclosure, illustrate various embodiments of the present disclosure. As illustrated in the drawings, embodiments of the disclosure show an application (App) that includes a user interface as noted in FIG. 1.

FIG. 1 is a user interface 4 of the App in accordance with at least one example embodiment where a user is allowed to enter his or her name, height 1, and sexual orientation. The App uses a series of capture, analysis, and conversion data initiated from an image capture found when a user presses a Compare Function 2. The first step to initiate image capture is to press the Start/360 image capture button 3.

FIG. 2 illustrates a rotational analysis conducted by at least one technology example embodiment of the disclosure within the App which requires an image subject person 10 to rotate in a 360 degree angle (or 360 degrees). As the subject person 10 rotates, images are captured which allow dimensional analysis of the body to occur.

FIG. 3 illustrates a comparative analysis of one image to another to reveal loss or gain on any individual part of a human body and the subsequent workout recommendation results produced in accordance with at least one example embodiment of the disclosure. An initial body scan 100 in FIG. 3 refers to an initial body scan of the arm and body scan 200 refers to a future scan providing a loss or gain in the arm. Scans 300 and 400 represent an initial scan of the leg and future scan of the leg, respectively, the result being the loss or gain difference between the two scans. Image scans 500 and 600 refer to an initial scan of the stomach and future scan, respectively.

FIG. 4 is a flow chart of a method for determining and receiving workout recommendations based on image dimensional changes to body parts in accordance with at least one example embodiment; and

FIG. 5 is a block diagram of a computing device in accordance with at least one example embodiment.

### DETAILED TECHNICAL DESCRIPTION

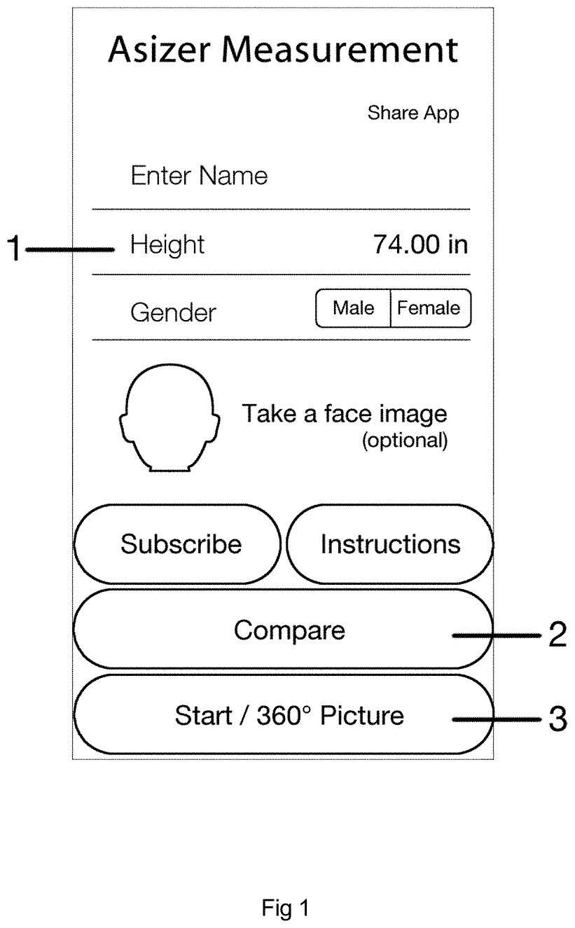

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. FIG. 1 is a user interface of the App in accordance with at least one example embodiment where a user is allowed to enter his or her name, height, and sexual orientation. The App uses a series of capture, analysis, and conversion data initiated from an image capture found when a user presses a Compare Function 2. The first step to initiate image capture is to press the Start/360 image capture button 3.

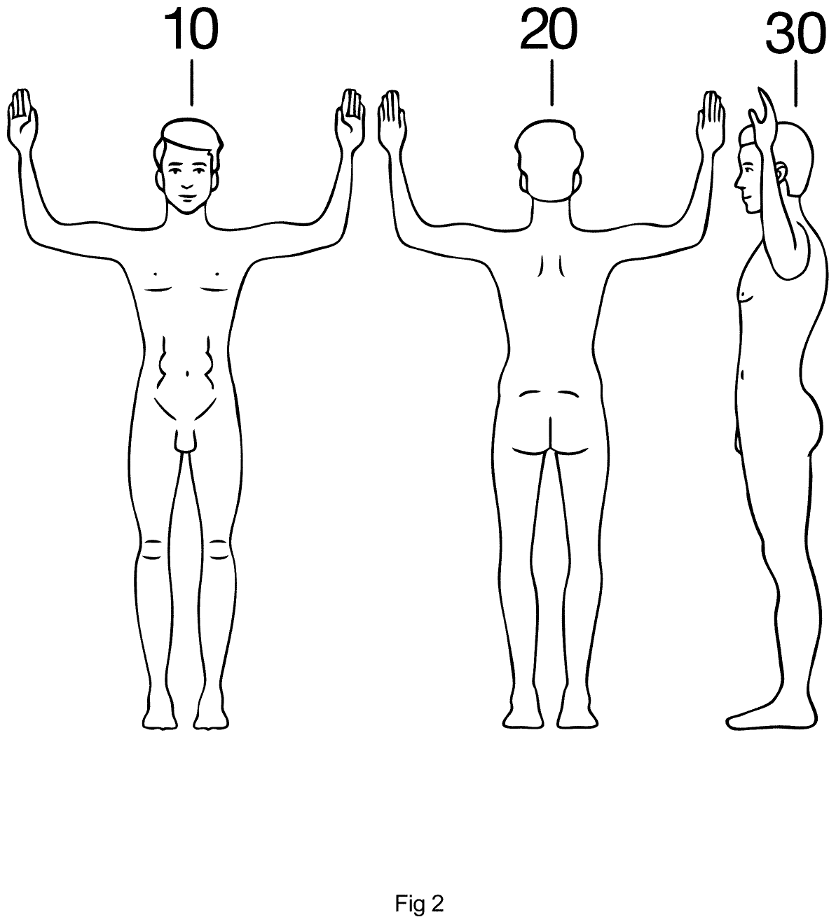

FIG. 2 illustrates a rotational analysis conducted by at least one technology example embodiment of the disclosure within the App which require an image subject person 10 to rotate in a 360 degree angle (or 360 degrees). As the subject person 10 rotates, images are captured which allow dimensional analysis of the body to occur.

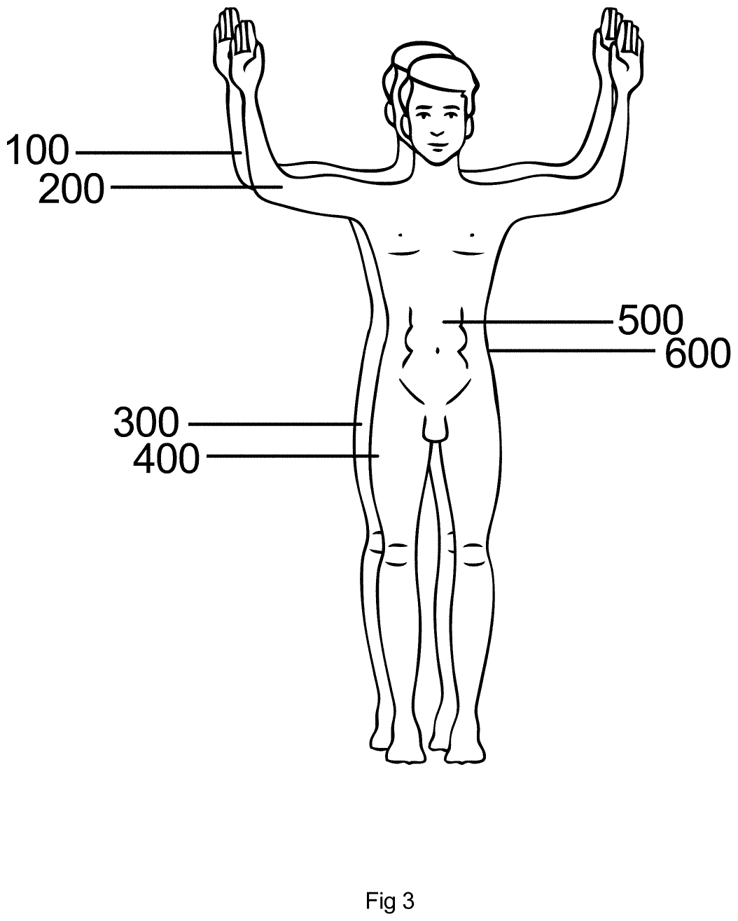

FIG. 3 illustrates a comparative analysis of one image to another to reveal loss or gain on any individual part of a human body and the subsequent workout recommendation results produced in accordance with at least one example embodiment if the disclosure. An initial body scan 100 in FIG. 3 refers to an initial body scan of the arm and body scan 200 refers to a future scan providing a loss or gain in the arm. Scans 300 and 400 represent an initial scan of the leg and future scan of the leg, respectively, the result being the loss or gain difference between the two scans. Image scans 500 and 600 refer to an initial scan of the stomach and future scan, respectively.

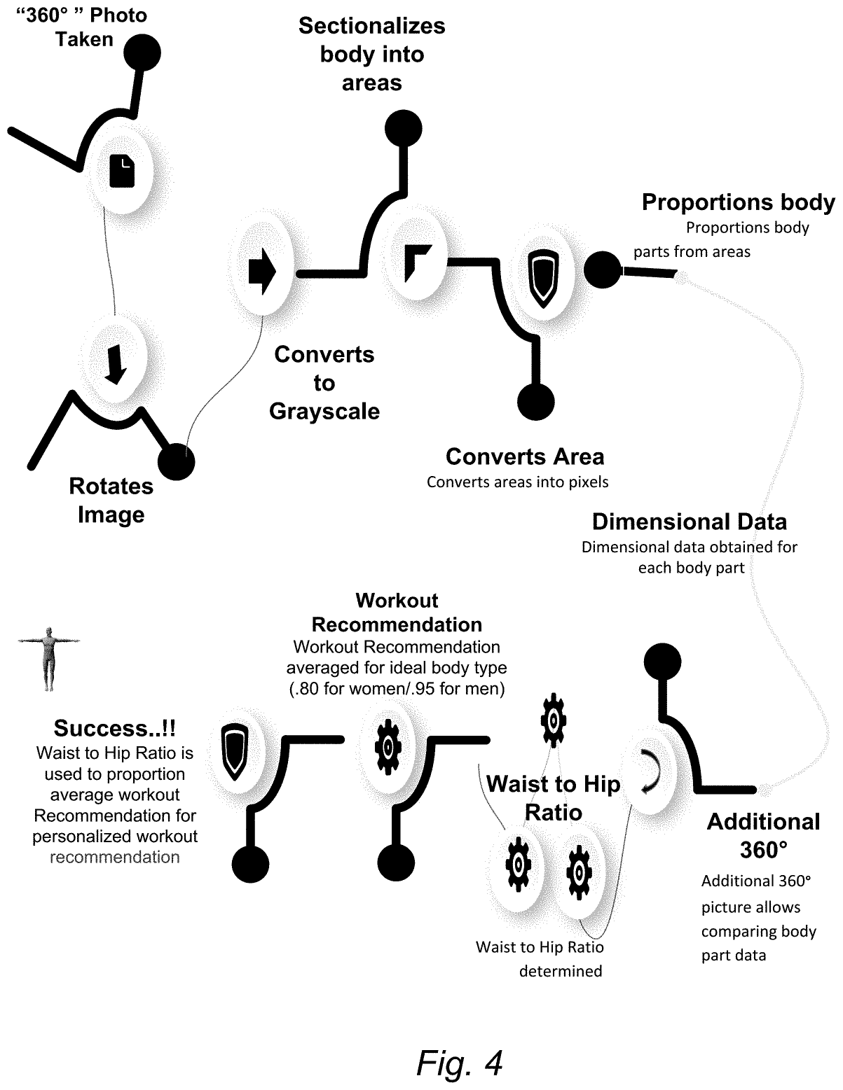

FIG. 4 is a flow chart of a method for determining and receiving workout recommendations based on image dimensional changes to body parts in accordance with at least one example embodiment The technology embodiments of this disclosure involve creating a 3D model of a human body using a 360 degree rotational image, calculating the pixels within that image, and using the height of that person, converting pixels to metric dimensional sizing data. This is then used to determine the hip to waist ratio by dividing the hip dimensional measurement by the waist dimensional measurement to determine workout recommendations. A survey of fitness professionals determined the best workout routine for an individual with an average hip to waist ratio of 70. This result contained workout type and repetition frequency. Thus, with technology embodiments of the disclosure, a personalized workout recommendation may be derived by dividing their personalized hip to waist ratio by a standard baseline value (0.80 for female) and (0.95 for male) and multiplying that result by the workout frequency to provide a personalized workout suggestion.

In order to account for individual body types and shapes, embodiments of the disclosure include taking into account each waist to hip ratio in relation to the average statistical normal for both men and women expressed in a factor number and multiplying this factor by the statistical average frequency in repetitions to provide a personalized workout frequency and routine. To account for the individual ability to complete recommended workouts, an inverse factor may be applied to allow less intense workouts for less healthy individuals who are more obese with a higher BMI or Waist to Hip Ratio and more intense workouts for healthier individuals who are less obese with a lower BMI.

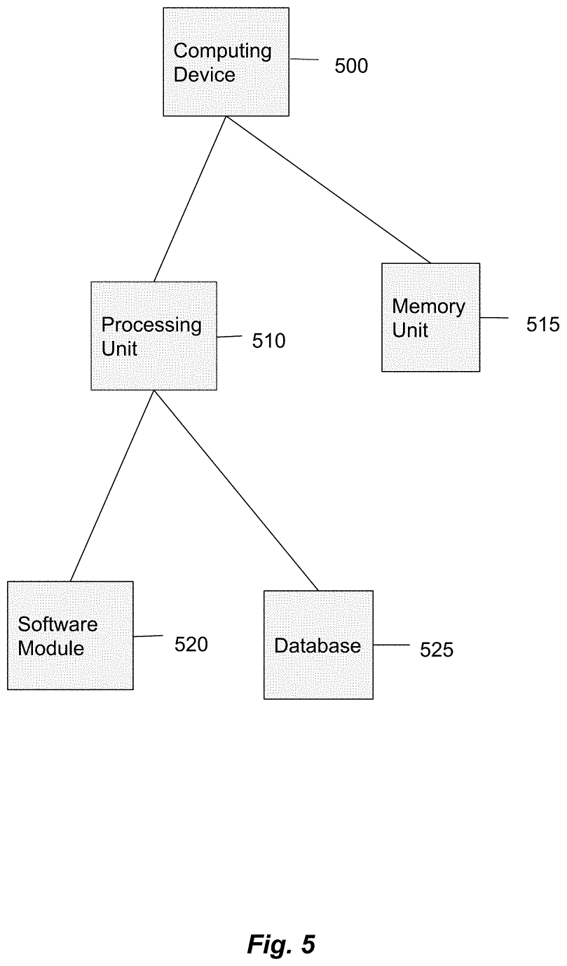

FIG. 5 shows computing device 500. As shown in FIG. 5, computing device 500 may include a processing unit 510 and a memory unit 515. Memory unit 515 may include a software module 520 and a database 525. While executing on processing unit 510, software module 520 may perform processes for determining and receiving workout recommendations, including for example, any one or more of the stages from method method 400 described above with respect to FIGS. 1-4. Computing device 500, for example, may provide an operating environment for user interface 4 of the App in a user is allowed to enter his or her name, height 1, and sexual orientation; the App series of capture, analysis, and conversion data initiated from an image capture found when a user presses a Compare Function 2; and the Start/360 image capture button 3 may operate in other environments and is not limited to computing device 500.

Computing device 500 may be implemented using a Wi-Fi access point, a cellular base station, a tablet device, a mobile device, a smart phone, a telephone, a remote control device, a set-top box, a digital video recorder, a handheld scanner, a cable modem, a personal computer, a network computer, a mainframe, a router, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. Furthermore, computing device 500 may comprise, for example, a mobile terminal, such as a smart phone, a cellular telephone, a cellular telephone utilizing Wireless Application Protocol (WAP) or unlicensed mobile access (UMA), personal digital assistant (PDA), intelligent pager, portable computer, a hand-held computer, a conventional telephone, or a Wireless Fidelity (Wi-Fi) access point. The aforementioned systems and devices are examples and computing device 500 may comprise other systems or devices.

The computer-usable or computer-readable medium may be, for example but not limited to, an electronic, magnetic, optical, electromagnetic, infrared, or semiconductor system, apparatus, device, or propagation medium. More specific compute readable medium examples (a non-exhaustive list), the computer-readable medium may include the following: an electrical connection having one or more wires, a portable computer diskette, a random access memory (RAM), a read-only memory (ROM), an erasable programmable read-only memory (EEPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Moreover, the semantic data consistent with embodiments of the disclosure may be analyzed without being stored. In this case, in-line data mining techniques may be used as data traffic passes through, for example, a caching server or network router. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the components illustrated in FIGS. 1-4, may be integrated onto a single integrated circuit Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 500 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart For example, two blocks shown in succession may in fact be executed substantially concurrently or the blocks may sometimes be executed in the reverse order, depending upon the functionality acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method for determining workout recommendations, comprising:
utilizing image capture and comparative analysis to obtain 360 degree body image of a person;
converting the 360 degree body images to one or more dimensional references;
utilizing a height of the person and the dimensional references to create dimensional data for any body part of the person; and
comparing the dimensional data of one body part from a first image capture session to the dimensional data of that same body part from a second image capture session to determine dimensional loss or gain from the first image capture session to the second image capture session.

2. The method of claim 1, further comprising utilizing high definition video resolution and pixel per metric conversion statistics to obtain the one or more 360 degree body part images of the person.

3. The method of claim 1, wherein converting the 360 degree body images to one or more dimensional references comprises:
rotating the body image,
converting the body image to grayscale,
generating an outline view of the body image; and
creating boundary lines in the outline view there in separating individual body parts of the body image within segregated boxes

4. The method of claim 3, further comprising shading the individual body parts within the segregated boxes, converting each box into pixels therein shading an inner section of each body part to segregate the inside area of each body part from its segregated box, and using a pixel per metric algorithm, therein converting pixels into dimensional measurements and proportioning out body parts within the shaded areas of each segregated box to determine the dimensional data for each body part.

5. The method of claim 1, further comprising utilizing the dimensional data to calculate a waist to hip ratio therein dividing the dimensional data of waist by the dimensional data of hip in order to provide the waist to hip ratio from the first or second session for the person.

6. The method of claim 5, further comprising comparing the waist hip ratio calculated to a statistical average waist to hip ratio for average men (0.90) or to an average waist to hip ratio for women (0.80) and multiplying that result by an average recommended workout routine; utilizing the multiplied result to provide a personalized workout routine for the person.

7. The method of claim 6, further comprising gathering the average waist to hip ratio, average BMI, and average individual body part measurements from, dimensional data acquired from all sessions per person and obtaining au average waist to hip ratio, average BMI, and average individual body part measurements based on groupings by age, race, gender, or height, therein allowing any user to compare their waist to hip ratio, BMI, or individual body dimensions to averages using a search query.

8. The method of claim 6, further comprising adjusting workout recommendations for projected ability or workout skill level therein including a factor that is an inverse of a BMI of a person multiplied by a number of workout repetitions to calculate a recommended workout frequency.

9. The method of claim 1, applying the dimensional loss or gain of the person to understanding clothing preferences, dietary suggestions, or workout recommendations to influence health outcomes of that person.

10. The method of claim 1 wherein utilizing a height of the person and the dimensional references to create dimensional data for any body part of the person comprises:
gauging a current state of each individual part of a person's body
utilizing the dimensional data to calculate a waist to hip ratio
comparing the waist to hip ratio to industry standards; and
further comprising adjusting industry standard workout recommendations based on the waist to hip ratio to obtain personalized workout recommendations for the person.

11. A computer storage medium storing instructions comprising a workout recommendation application that, when executed by a processor, cause the processor to perform operations comprising:
providing a workout recommendation user interface for receiving data;
utilizing image capture and comparative analysis to obtain a 360 degree body image of a person;
converting the 360 degree body images to one or more dimensional references;
utilizing a height of the person and the dimensional references to create dimensional data for any body part of the person; and
comparing the dimensional data of one body part from a first image capture session to the dimensional data of that same body part from a second image capture session to determine dimensional loss or gain from the first image capture session to the second image capture session.

12. The computer storage medium of claim 11, wherein converting the 360 degree body images to one or more dimensional references comprises:
rotating the body image,
converting the body image to grayscale,
generating an outline view of the body image; and
creating boundary lines in the outline view there in separating individual body parts of the body image within segregated boxes.

13. The computer storage medium of claim 11, when executed by a processor, cause the processor to perform operations further comprising:
utilizing the dimensional data to calculate a waist to hip ratio therein dividing the dimensional data of a waist by the dimensional data of a hip in order to provide the waist to hip ratio from the first or second session for the person;
comparing the waist hip ratio calculated to a statistical average waist to hip ratio for average men or to an average waist to hip ratio for women;
multiplying that result by an average recommended workout routine; and
utilizing the multiplied result to provide a personalized workout routine for the person.

14. A system comprising:
a processor; and
a memory storing instructions comprising a workout recommendation application that, when executed by the processor, cause the processor to perform operations comprising:
providing a workout recommendation user interface for receiving data;
utilizing image capture and comparative analysis to obtain a 360 degree body image of a person;
converting the 360 degree body images to one or more dimensional references;
utilizing a height of the person and the dimensional references to create dimensional data for any body part of the person; and
comparing the dimensional data of one body part from a first image capture session to the dimensional data of that same body part from a second image capture session to determine dimensional loss or gain from the first image capture session to the second image capture session.

15. The system of claim 14, wherein the operations further comprise:
utilizing the dimensional data to calculate a waist to hip ratio therein dividing the dimensional data of a waist by the dimensional data of a hip in order to provide the waist to hip ratio from the first or second session for the person;
comparing the waist hip ratio calculated to a statistical average waist to hip ratio for average men or to an average waist to hip ratio for women;
multiplying that result by an average recommended workout routine; and
utilizing the multiplied result to provide a personalized workout routine for the person.
